(19) United States
(12) Patent Application Publication
(10) Pub. No.: US 2026/0203636 A1
(43) Pub. Date: Jul. 16, 2026

(54) METHOD FOR PLANNING PHYSICAL OBSERVATION TASKS IN SPACE-AIR-GROUND INTEGRATED SENSOR NETWORK

(71) Applicant: CHINA UNIVERSITY OF GEOSCIENCES (WUHAN), Wuhan (CN)

(72) Inventors: Jie LI, Wuhan (CN); Chuli HU, Wuhan (CN); Xuan DING, Wuhan (CN); Ke WANG, Wuhan (CN); Nengcheng CHEN, Wuhan (CN)

(73) Assignee: CHINA UNIVERSITY OF GEOSCIENCES (WUHAN), Wuhan (CN)

(21) Appl. No.: 19/566,103

(22) Filed: Mar. 13, 2026

(30) Foreign Application Priority Data
Dec. 31, 2025 (CN) 202512047643.2

(51) Int. Cl. G06N 10/60; G06N 10/20

(52) U.S. Cl. CPC G06N 10/60; G06N 10/20

(57) ABSTRACT

A method for planning physical observation tasks in a space-air-ground integrated sensor network includes: obtaining capability data of available space-air-ground sensors, discretizing a spatiotemporal range of a monitoring scenario, and establishing spatial, temporal, and spatiotemporal mapping relationships between discretized spatiotemporal locations and sensor capabilities; performing quantum encoding on the spatiotemporal locations, sensors, and observation capabilities, and executing a quantum entanglement operation based on the constructed three types of mapping relationships, to build a unified quantum state representation of the spatiotemporal observation capabilities of the space-air-ground sensors; for a specific computation requirement, constructing a corresponding quantum operator and applying a quantum algorithm to perform efficient computation and measurement on the unified quantum state representation to obtain a computation result, thereby enabling scheduling of the space-air-ground integrated sensor network. The inherent bottlenecks in representing and computing spatiotemporal observation capabilities in the classical computation framework are resolved.

### CROSS-REFERENCE TO RELATED APPLICATIONS

This application claims priority to Chinese Patent Application No. 202512047643.2 with a filing date of Dec. 31, 2025. The content of the aforementioned application, including any intervening amendments thereto, is incorporated herein by reference.

### TECHNICAL FIELD

The present application relates to the field of quantum computation, and in particular, to a method for planning physical observation tasks in a space-air-ground integrated sensor network.

### BACKGROUND

In numerous critical application fields, such as disaster emergency response, dynamic environment monitoring, and comprehensive perception for smart cities, timely and comprehensive spatiotemporal information forms the foundation for scientific decision-making and efficient action. Space-air-ground sensors (such as satellites, airborne remote sensing platforms, and ground-based monitoring stations) constitute the core infrastructure for obtaining such information. However, the essential prerequisite for efficient planning and scheduling of these vast, heterogeneous, and ubiquitous sensor resources is a comprehensive and dynamic cognition of spatiotemporal observation capabilities of the sensors. The spatiotemporal observation capabilities of the sensors, including not only static attributes such as a spatiotemporal resolution and an observation parameter but also dynamic states such as earth observation coverage and remaining storage capacity, serve as a core metric for evaluating the observation efficacy. Notably, with the massive deployment of space-air-ground sensors, the aggregated spatiotemporal observation capabilities are evolving into a novel and complex data resource that urgently requires efficient management. This challenge is particularly pronounced in sudden disaster scenarios such as urban waterlogging. Such scenarios impose extremely high requirements on the real-time performance and comprehensiveness of disaster monitoring, which heavily relies on comprehensive, fine-grained cognition and efficient planning and scheduling of available sensors and capabilities thereof. Therefore, how to efficiently and comprehensively represent and compute this complex spatiotemporal observation capability, and apply the capability to planning physical observation tasks within a space-air-ground integrated sensor network, has become a critical technical problem of universal significance that urgently needs to be resolved.

Currently, modeling of the spatiotemporal observation capability for space-air-ground sensors is primarily based on the object, field, and object-field models from geographic information science. The object model features comprehensive capability representation but complex queries; the field model offers easy queries but incomplete representation; while the object-field model aims to combine the advantages of both. Specifically, object-field-based modeling first models spatiotemporal locations as a field, then models sensors and corresponding capabilities as objects, subsequently establishes an associative mapping between the field and the objects, and ultimately achieves location-based multi-sensor capability representation and computation. However, under the classical computation framework, this method suffers from inherent representation and computation deficiencies. As the number of space-air-ground sensors and the spatiotemporal scale and resolution of target scenarios increase, the complexity of representing and computing the spatiotemporal observation capabilities grows explosively. For example, when spatial and temporal resolutions are increased by a factor of n, respectively, the space complexity of capability representation and the time complexity of capability computation correspondingly increase by at least a factor of n³. This severely constrains the cognition accuracy and efficiency of the spatiotemporal observation capability, thereby hindering efficient and reliable sensor query, discovery, planning, and scheduling. Therefore, how to break through the bottlenecks in representation and computation of spatiotemporal observation capabilities under the classical computation framework is the core technical challenge that currently demands immediate resolution.

In 1982, Feynman proposed the concept of the “quantum computer.” This is a novel computational paradigm based on quantum mechanics (for example, quantum superposition and entanglement), which leverages inherent quantum parallelism and is widely acknowledged to possess computational power far surpassing classical computers for specific problems. After over forty years of development, significant progress has been made in both quantum computing hardware (with universal quantum computers of several hundred qubits now realized) and theory (such as Shor's algorithm and Grover's algorithm). Notably, in recent years, quantum computing has been successfully applied to image representation and computation, especially in processing raster images similar to the field model, achieving representation and computation efficiency superior to classical methods. Although the structure of the object-field model is more complex, preventing direct application of such quantum field model algorithms, this provides crucial inspiration for utilizing quantum computing methods to break through the bottlenecks in representation and computation of spatiotemporal observation capabilities.

In summary, the primary issues regarding the representation and application of spatiotemporal observation capabilities for space-air-ground sensors are as follows:

Under the classical computation framework, even the most advanced existing modeling methods for spatiotemporal observation capabilities of space-air-ground sensors suffer from inherent representation and computation bottlenecks. With the future trend towards ubiquitous deployment of space-air-ground sensors and the evolution of monitoring demands towards higher spatiotemporal resolution, this classical computation bottleneck becomes increasingly prominent. This severely hinders the fine-grained and efficient cognition of the spatiotemporal observation capabilities, thereby constraining the timely discovery and reliable planning of space-air-ground sensors. Although quantum computing has demonstrated immense potential to overcome the aforementioned bottlenecks, there is currently a complete absence of research on planning physical observation tasks based on the quantum representation of this complex model of spatiotemporal observation capabilities of space-air-ground sensors. Therefore, pioneering the construction of methods for planning physical observation tasks within a space-air-ground integrated sensor network to break through classical limitations is crucial for achieving timely, accurate, and comprehensive monitoring of spatiotemporal information across heterogeneous scenarios.

### SUMMARY OF PRESENT INVENTION

The objective of the present disclosure is to address the problem encountered when planning observation tasks for a space-air-ground integrated sensor network under a classical computation framework. Specifically, due to the vast number of sensors and continuously increasing demands for spatiotemporal resolution, the system suffers from dual exponential growth in both space complexity and time complexity. As a result, efficient and real-time sensor capability representation and coordinated scheduling become impractical. To this end, the present disclosure provides a method for planning physical observation tasks in a space-air-ground integrated sensor network.

The above technical objective of the present application is achieved through the following technical solutions:
step S1: obtaining, by the processor, space-air-ground sensor data and spatiotemporal observation capability data of space-air-ground sensors in a specific monitoring scenario;
step S2: discretizing, by the processor, the specific monitoring scenario to obtain discrete spatiotemporal locations; and establishing three types of mapping relationships among the discrete spatiotemporal locations, the space-air-ground sensor data, and the spatiotemporal observation capability data;
step S3: performing, by the quantum processor, based on the three types of mapping relationships, quantum encoding on the discrete spatiotemporal locations, the space-air-ground sensor data, and the spatiotemporal observation capability data, to construct a unified quantum state representation of spatiotemporal observation capabilities of the space-air-ground sensors; and
step S4: constructing, by the quantum processor, a corresponding quantum operator and quantum circuit based on an obtained computation requirement on the spatiotemporal observation capabilities, applying a quantum algorithm to compute the quantum state representation of the spatiotemporal observation capabilities of the space-air-ground sensors to generate a computation result of the spatiotemporal observation capabilities; and dynamically adjusting an observation plan or an observation parameter of at least one sensor in the space-air-ground integrated sensor network based on the computation result, to perform collaborative physical observation of a target area.

Optionally, the step S1 includes:
step S11: determining a spatial extent and a temporal span of the specific monitoring scenario, where the spatial extent is delimited by one or more polygons; and the temporal span is delimited by a start time point and an end time point; and
step S12: obtaining a set of available space-air-ground sensors within the spatial extent and the temporal span, and determining spatiotemporal observation capability data for each space-air-ground sensor in the set of available space-air-ground sensors, where the spatiotemporal observation capability data includes: observation start and end time points, earth observation coverage, an observation parameter, and a sensing mode.

Optionally, the step S2 includes:
step S21: discretizing the spatial extent and the temporal span of the specific monitoring scenario, where the spatial extent is partitioned into one or more regular discrete grid cells according to a specific spatial resolution, and the temporal span is partitioned into one or more discrete time intervals according to a specific temporal resolution; and
step S22: establishing, based on the observation start and end time points and the earth observation coverage of each space-air-ground sensor, a spatiotemporal mapping relationship among each discrete grid cell within each discrete time interval, one or more sensors capable of observing the discrete grid cell within the discrete time interval, and spatiotemporal observation capabilities of the one or more sensors;
establishing a temporal mapping relationship among each discrete time interval, one or more sensors capable of observing at least one of the discrete grid cells within the discrete time interval, and spatiotemporal observation capabilities of the one or more sensors; and
establishing a spatial mapping relationship among each discrete grid cell, one or more sensors capable of observing the discrete grid cell within at least one of the discrete time intervals, and spatiotemporal observation capabilities of the one or more sensors, where

the three types of mapping relationships include: the spatiotemporal mapping relationship, the temporal mapping relationship, and the spatial mapping relationship.

Optionally, the step S3 includes:
step S31: performing quantum encoding to construct a spatiotemporal location quantum state representing the discrete grid cells and the discrete time intervals, where
the spatiotemporal location quantum state is used to identify a mode control quantum state for the spatial mapping relationship, the temporal mapping relationship, and the spatiotemporal mapping relationship, represent a sensor quantum state for the set of available space-air-ground sensors, and identify an observation capability quantum state including at least the observation parameter and the sensing mode; and
step S32: based on the three types of mapping relationships, performing a quantum entanglement operation using the mode control quantum state as a core control, to establish controllable associations among the spatiotemporal location quantum state, the sensor quantum state, and the observation capability quantum state, so as to form the unified quantum state representation of the spatiotemporal observation capabilities of the space-air-ground sensors.

Optionally, the step S4 includes:
step S41: for a specific query and computation requirement on the spatiotemporal observation capabilities, based on the quantum state representation of the spatiotemporal observation capabilities of the space-air-ground sensors, transforming the computation requirement into one or more quantum operators applicable to the quantum state representation, and constructing a corresponding quantum circuit;
step S42: executing the quantum circuit by applying the quantum algorithm, performing a measurement operation on an executed quantum state, and decoding a measurement result to obtain the computation result of the spatiotemporal observation capabilities.

Optionally, the quantum algorithm is a Grover's search algorithm, the quantum operator includes an Oracle operator and a Diffuser operator, and the computation requirement is a spatial location capable of being co-observed by at least two sensors within a specific time interval and corresponding observation capabilities.

A heterogeneous computing system including a processor and a quantum processor includes the processor, the quantum processor, a memory, a user interface, and a network interface, where the memory is configured to store instructions, the user interface and the network interface are used for communication with another device, and the processor and quantum processor are configured to execute the instructions stored in the memory.

A computer-readable storage medium stores instructions, and when the instructions are executed, the method for planning physical observation tasks in a space-air-ground integrated sensor network is executed.

The technical solutions provided in the present application have the following beneficial effects:

Reduction in space complexity: By leveraging the characteristics of quantum superposition and entanglement, discrete spatiotemporal locations, the sensors, and the observation capabilities are efficiently quantum-encoded and uniformly represented. This significantly reduces the resources required for storage and representation, overcoming the issue in the classical methods that space complexity increases drastically with higher resolution. Utilizing the advantage of quantum parallel computation and combining with the quantum algorithm such as the Grover's algorithm, complex query and computation tasks can be executed directly on quantum states. This substantially reduces computation time, demonstrating significant speed advantages, particularly in scenarios involving multi-sensor collaborative observation and spatiotemporal overlap analysis. The present application introduces quantum computation into the field of task planning for the space-air-ground sensor network, providing a viable quantum-enhanced solution for achieving efficient, precise, and real-time collaborative observation within the space-air-ground integrated sensor network.

### BRIEF DESCRIPTION OF THE DRAWINGS

The present application is described in further detail with reference to the accompanying drawings and embodiments. In the drawings:

FIG. 1 is a diagram showing steps of a method according to an embodiment of the present application;

FIG. 2 is a visualization example diagram showing a target area and earth observation coverage of available space-air-ground sensors according to an example of the present disclosure;

FIG. 3 is a visualization example diagram showing spatiotemporal discretization performed on a scenario according to an example of the present disclosure;

FIG. 4 is an example diagram showing a quantum circuit for performing quantum encoding according to an example of the present disclosure;

FIG. 5 is an example diagram showing a quantum circuit for constructing a unified quantum state representation according to an example of the present disclosure; and

FIG. 6 is an example diagram showing a quantum circuit for performing query and computation by applying the Grover's algorithm according to the present disclosure.

### DETAILED DESCRIPTION OF THE EMBODIMENTS

In order to describe the technical features, objectives and effects of the present application more clearly, the specific implementations of the present application are described in detail below with reference to the accompanying drawings.

An embodiment of the present application provides a method for planning physical observation tasks in a space-air-ground integrated sensor network.

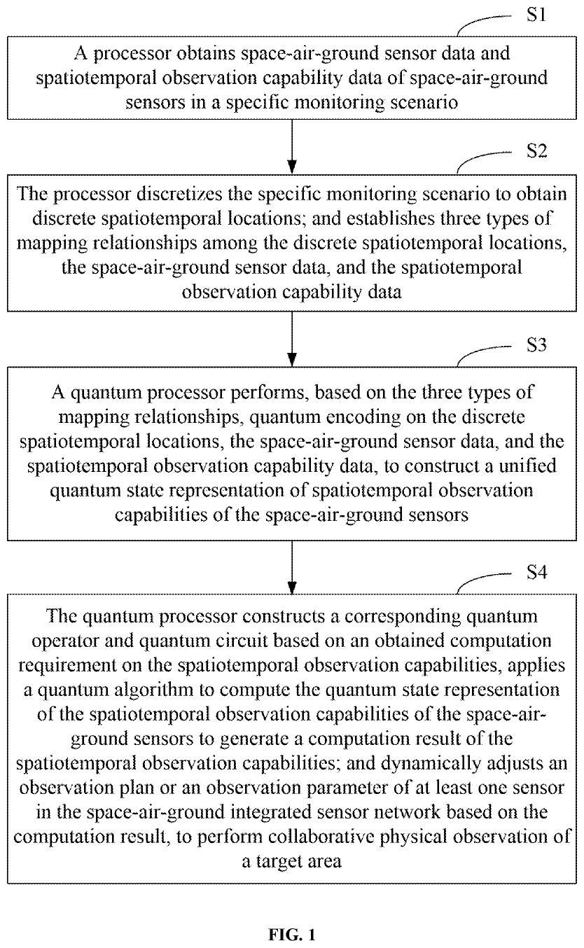

Referring to FIG. 1, FIG. 1 is a diagram showing steps of a method for planning physical observation tasks in a space-air-ground integrated sensor network according to an embodiment of the present application. The method includes the following steps.

In step S1, a processor obtains space-air-ground sensor data and spatiotemporal observation capability data of space-air-ground sensors in a specific monitoring scenario.

In step S2, the processor discretizes the specific monitoring scenario to obtain discrete spatiotemporal locations; and establishes three types of mapping relationships among the discrete spatiotemporal locations, the space-air-ground sensor data, and the spatiotemporal observation capability data.

In step S3: a quantum processor performs, based on the three types of mapping relationships, quantum encoding on the discrete spatiotemporal locations, the space-air-ground sensor data, and the spatiotemporal observation capability data, to construct a unified quantum state representation of spatiotemporal observation capabilities of the space-air-ground sensors.

In step S4: the quantum processor constructs a corresponding quantum operator and quantum circuit based on an obtained computation requirement on the spatiotemporal observation capabilities, applies a quantum algorithm to compute the quantum state representation of the spatiotemporal observation capabilities of the space-air-ground sensors to generate a computation result of the spatiotemporal observation capabilities; and dynamically adjusts an observation plan or an observation parameter of at least one sensor in the space-air-ground integrated sensor network based on the computation result, to perform collaborative physical observation of a target area.

The step S1 includes the following steps:

In step S11: a spatial extent and a temporal span of the specific monitoring scenario are determined. The spatial extent is delimited by one or more polygons; and the temporal span is delimited by a start time point and an end time point.

In step S12: a set of available space-air-ground sensors within the spatial extent and the temporal span is obtained, and spatiotemporal observation capability data for each space-air-ground sensor in the set of available space-air-ground sensors is determined. The spatiotemporal observation capability data includes: observation start and end time points, earth observation coverage, an observation parameter, and a sensing mode.

The step S2 includes the following steps:

In step S21, the spatial extent and the temporal span of the specific monitoring scenario are discretized. The spatial extent is partitioned into one or more regular discrete grid cells according to a specific spatial resolution, and the temporal span is partitioned into one or more discrete time intervals according to a specific temporal resolution.

In step S22, based on the observation start and end time points and the earth observation coverage of each space-air-ground sensor, a spatiotemporal mapping relationship among each discrete grid cell within each discrete time interval, one or more sensors capable of observing the discrete grid cell within the discrete time interval, and spatiotemporal observation capabilities of the one or more sensors is established.

A temporal mapping relationship among each discrete time interval, one or more sensors capable of observing at least one of the discrete grid cells within the discrete time interval, and spatiotemporal observation capabilities of the one or more sensors is established.

A spatial mapping relationship among each discrete grid cell, one or more sensors capable of observing the discrete grid cell within at least one of the discrete time intervals, and spatiotemporal observation capabilities of the one or more sensors is established.

The three types of mapping relationships include: the spatiotemporal mapping relationship, the temporal mapping relationship, and the spatial mapping relationship.

The step S3 includes the following steps:

In step S31, quantum encoding is performed to construct a spatiotemporal location quantum state representing the discrete grid cells and the discrete time intervals.

The spatiotemporal location quantum state is used to identify a mode control quantum state for the spatial mapping relationship, the temporal mapping relationship, and the spatiotemporal mapping relationship, represent a sensor quantum state for the set of available space-air-ground sensors, and identify an observation capability quantum state including at least the observation parameter and the sensing mode.

In step S32, based on the three types of mapping relationships, a quantum entanglement operation is performed using the mode control quantum state as a core control, to establish controllable associations among the spatiotemporal location quantum state, the sensor quantum state, and the observation capability quantum state, so as to form the unified quantum state representation of the spatiotemporal observation capabilities of the space-air-ground sensors.

The step S4 includes the following steps:

In step S41, for a specific query and computation requirement on the spatiotemporal observation capabilities, based on the quantum state representation of the spatiotemporal observation capabilities of the space-air-ground sensors, the computation requirement is transformed into one or more quantum operators applicable to the quantum state representation, and a corresponding quantum circuit is constructed.

In step S42, the quantum circuit is executed by applying the quantum algorithm, a measurement operation is performed on an executed quantum state, and a measurement result is decoded to obtain the computation result of the spatiotemporal observation capabilities.

The quantum algorithm is a Grover's search algorithm, the quantum operator includes an Oracle operator and a Diffuser operator, and the computation requirement is a spatial location capable of being co-observed by at least two sensors within a specific time interval and corresponding observation capabilities.

In a preferred embodiment of the present disclosure, an urban waterlogging event in a specific city is selected as a typical application scenario. The city is located at the confluence of the Yangtze River and the Han River, characterized by a dense river network and low-lying terrain. Frequent extreme rainfall leads to significant waterlogging pressure. This embodiment aims to perform quantum representation and computation of spatiotemporal observation capabilities of space-air-ground sensors in the urban waterlogging monitoring scenario, thereby validating the applicability and superiority of the present disclosure. The overall procedure is shown in FIG. 1.

In step S1-1, a spatial extent and a temporal span of the urban waterlogging monitoring scenario are determined.

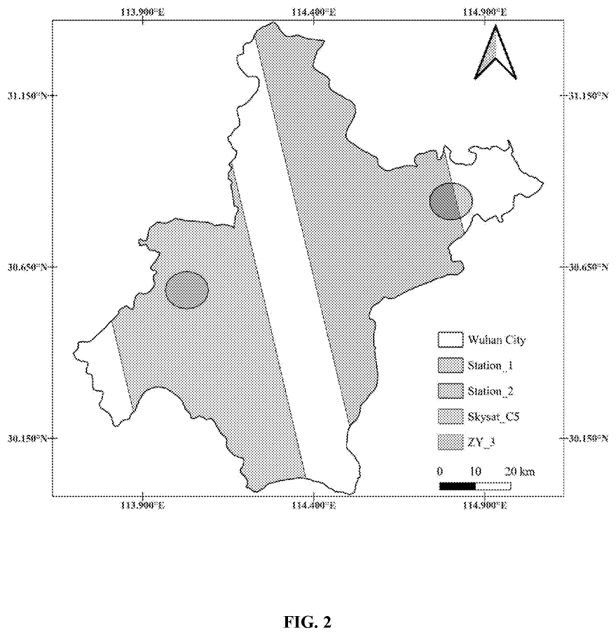

The scenario is determined as an urban waterlogging event in the city caused by an extreme rainfall event on Aug. 13, 2021. The spatial extent is determined as a polygon (shown in FIG. 2) representing the main urban area of the city. The temporal span is specifically determined as 14:00:00 to 14:30:00 on Aug. 13, 2021.

In step S1-2, a set of available space-air-ground sensors and spatiotemporal observation capabilities are obtained.

By querying and computing a publicly available space-air-ground sensor database, four available sensors and corresponding spatiotemporal observation capability attributes in the waterlogging monitoring scenario in the city are obtained. FIG. 2 shows the earth observation coverage of the obtained space-air-ground sensors. Table 1 shows the overpass start and end time points, observation parameters, and sensing modes of the obtained space-air-ground sensors.

TABLE 1
Set of available space-air-ground sensors and partial observation capability information

| | | Overpass/observation start | | |
|---|---|---|---|---|
| No. | Sensor name | and end time points | Observation parameters | Sensing mode |
| 1 | ZY_3 | 14:24:10-14:24:30 | Inundation extent | Remote sensing |
| 2 | Skysat_C5 | 14:01:40-14:02:00 | Flow velocity | Remote sensing |
| 3 | Station_1 | 14:00:00-14:30:00 | Water level, inundation | In situ |
| | | | extent | |
| 4 | Station_2 | 14:00:00-14:30:00 | Inundation extent, flow | In situ |
| | | | velocity | |

In step S2-1, spatiotemporal discretization is performed.

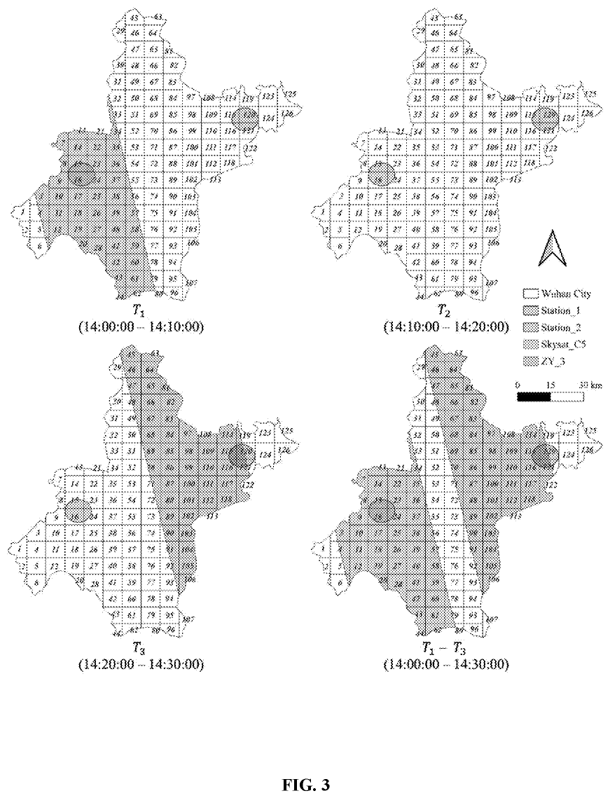

As shown in FIG. 3, a spatial resolution of 9 km is set, and the spatial extent of the main urban area in the city is gridded into M=126 discrete grid cells. A temporal resolution of 10 minutes is set, dividing the 30-minute temporal span into N=3 discrete time intervals.

In step S2-2, spatiotemporal mappings are constructed.

A spatiotemporal mapping table is established through calculations on spatial intersection and temporal overlap, with a logical structure expressed as: (Cellᵢ, Timeⱼ)→(Sensorₖ, Sensorₚ, . . . ). This structure denotes a set of sensors capable of monitoring a grid cell i during a time interval j. For example, (Cell₁₅, Time₁)→(Skysat_C5,Station_1). Subsequently, the spatiotemporal mapping table is aggregated by a time interval (Timeⱼ) to obtain a temporal mapping relationship (Timeⱼ)→ (Sensorₖ, Sensorₚ, . . . ). For example, (Time₁)→ (Skysat_C5,Station_1,Station_2). Finally, the spatiotemporal mapping table is aggregated by a grid cell (Cellᵢ) to obtain a spatial mapping relationship (Cellᵢ)→ (Sensorₖ, Sensorₚ, . . . ). For example, (Cell₁₁₅)→(ZY_3,Station_2).

In step S3-1, quantum encoding is performed.

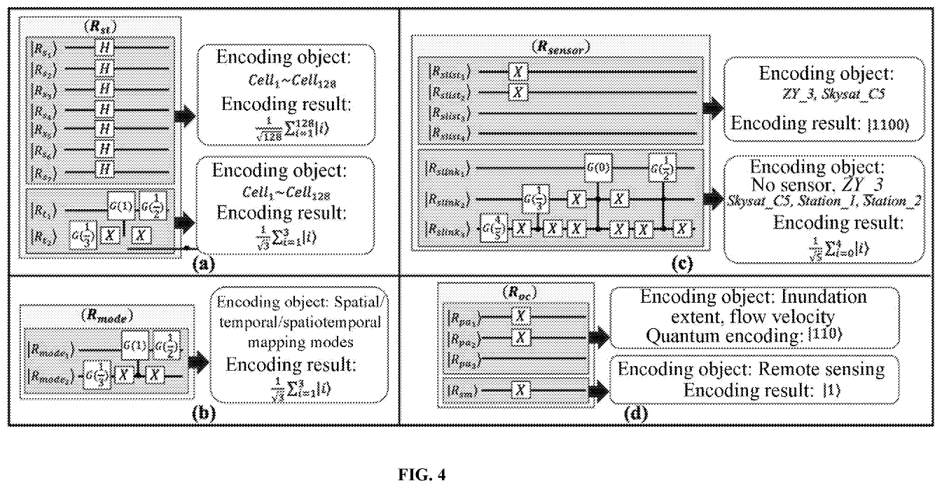

As shown in FIG. 4, the following quantum registers can be constructed and subjected to quantum encoding (binary encoding):
(1) A spatiotemporal location register (Rₛₜ) includes a spatial grid register (Rₛ) and a time interval register (Rₜ). Rₛ uses nₛ=┌log₂M┘ qubits to construct a uniform superposition state

$$\frac{1}{\sqrt{M}} {\sum }_{i = 1}^{M} \vert i 〉$$

for encoding each grid cell Cellᵢ; Rₜ uses nₜ=┌log₂N┐ qubits to construct a uniform superposition state

$$\frac{1}{\sqrt{N}} {\sum }_{i = 1}^{N} \vert i 〉$$

for encoding each time interval Timeⱼ. In this example, nₛ=┌log₂ 126┐=7, and nₜ=┌log₂3ℏ=2. For example, Cell₁₅ can be expressed as |15 [symbol] =|0001111 [symbol] , and Time₂ can be expressed as |2 [symbol] =|10 [symbol] .
(2) A mode control register (R_{mode}) is used to represent three mapping modes, and uses n_{mode}=┌log₂³┐=2 qubits to construct a uniform superposition state

$$\frac{1}{\sqrt{3}} {\sum }_{i = 1}^{3} ( \vert 10 〉 + \vert 01 〉 + \vert 11 〉 )$$

for encoding. |01 [symbol] denotes spatial mapping, |10 [symbol] denotes temporal mapping, and |11) denotes spatiotemporal mapping.
(3) A sensor register (Rₛₑₙₛₒᵣ) includes a sensor list register (Rₛₗᵢₛₜ) and a sensor link register (Rₛₗᵢₙₖ). Rₛₗᵢₛₜ uses nₛₗᵢₛₜ=k qubits to represent k sensors, encoded as |q₁q₂ . . . qₖ [symbol] . A state of an i^{th} qubit indicates whether an i^{th} sensor presents. In this example, qubit numbers are mapped to sensor numbers shown in Table 1. For example, |1100 [symbol] indicates the presence of ZY_3 and Skysat_C5. Rₛₗᵢₙₖ uses Nₛₗᵢₙₖ=┌log₂(k+1)┐ qubits to represent k sensors and a “no sensor” state, encoded as a uniform superposition state

$$\frac{1}{\sqrt{k + 1}} {\sum }_{i = 1}^{k + 1} \vert i 〉 .$$

The fixed encode |000 [symbol] indicates the absence of a sensor. In this example, |001 [symbol] is used to represent ZY_3, |010 [symbol] to represent Skysat_C5, |011 [symbol] to represent Station_1, and |100 [symbol] to represent Station 2.
(4) An observation capability register (R_{oc}) includes an observation parameter register (Rₚₐ) and a sensing mode register (Rₛₘ). Rₚₐ uses nₚₐ=p qubits to represent p observation parameters, encoded as |q₁q₂ . . . qₚ [symbol] . A state of an i^{th} qubit indicates whether an i^{th} observation parameter can be observed. In this example, three qubits are defined to represent “inundation extent”, “flow velocity”, and “water level” in sequence. For example, |110 [symbol] indicates that the inundation extent and flow velocity can be observed. Rₛₘ uses nₛₘ=1 qubit to represent the sensing mode. A state |0 [symbol] indicates in situ sensing, and a state |1 [symbol] indicates remote sensing.

In step S3-2, quantum state representations are unified.

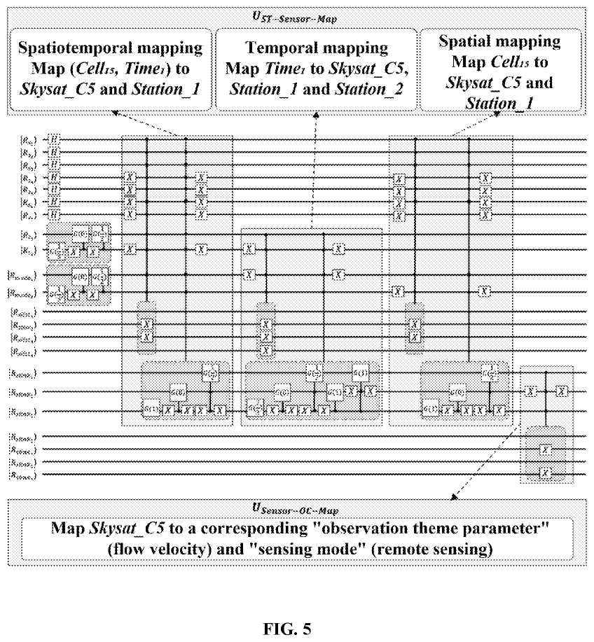

This step aims to construct two types of controlled unitary operators according to the mapping relationships established in the step S2-2, to achieve entanglement among the quantum registers prepared in the step S3-1.
(1) Spatiotemporal-sensor entanglement (U_{ST-Sensor-Map}) entangles spatiotemporal locations with corresponding space-air-ground sensors based on a selected mapping mode. To this end, Rₛₜ and R_{mode} are selected as control qubits, and Rₛₑₙₛₒᵣ is selected as a target qubit. U_{ST-Sensor-}Map is constructed as follows: When R_{mode}=|01 [symbol] , Rₛ from Rₛₜ is entangled with Rₛₑₙₛₒᵣ based on the spatial mapping; when R_{mode}=|10 [symbol] , Rₜ from Rₛₜ is entangled with Rₛₑₙₛₒᵣ based on the temporal mapping; and when R_{mode}=|11 [symbol] , Rₛₜ is entangled with Rₛₑₙₛₒᵣ based on the spatiotemporal mapping. FIG. 5 shows quantum circuit implementation of U_{ST-Sensor-Map} for a specific spatiotemporal unit (Cell₁₅, Time₁) under the control of the three different modes. G(x) represents an RY rotation gate operation, defined as RY(2·arccos(x)).
(2) Sensor-capability entanglement (U_{sensor-OC-Map}) entangles sensors with attributes such as observation parameters and sensing modes. To this end, Rₛₗᵢₙₖ from Rₛₑₙₛₒᵣ is selected as a control qubit, and R_{oc} is selected as a target qubit. U_{Sensor-OC-Map} is constructed as follows: Each sensor basis vector |k [symbol] in Rₛₗᵢₙₖ is entangled with corresponding observation capability attributes (Rₚₐ and Rₛₘ). FIG. 5 shows an example quantum circuit for executing this entanglement on Skysat_C5.

Finally, based on the mapping relationships in the step S2-2, by sequentially applying the operators U_{ST-Sensor-Map} and U_{sensor-OC-Map} in full, a unified quantum state representation |ψ_{ST-Sensor-oc}) of the spatiotemporal observation capabilities of space-air-ground sensors is formed from the initial state prepared in the step S3-1. Notably, the product of the two core entanglement operators is defined as a complete unified representation operator UST-Sensor-oc. Furthermore, by constructing a complete quantum state representation circuit for the waterlogging monitoring scenario and performing 1024 measurement operations (Table 2 presents partial measurement results), the correctness and effectiveness of the quantum representation method proposed in the present disclosure are verified. Table 3 further compares the space complexity of the proposed quantum representation method with the classical representation method (object-field model) in terms of the spatiotemporal location (Rₛₜ), the sensor (Rₛₑₙₛₒᵣ), and the observation capability (R_{oc}). The results demonstrate that the present disclosure provides an effective technical approach for the efficient and precise cognition of the spatiotemporal observation capability of the space-air-ground sensors in the urban waterlogging monitoring scenario with significantly lower space complexity.

TABLE 2
Partial measurement results of the unified space-air-ground sensor quantum state and
decoded information thereof

| No. | Rₛ | Rₜ | R_{mode} | Rₛₗᵢₛₜ | Rₛₗᵢₙₖ | Rₚₐ | Rₛₘ |
|---|---|---|---|---|---|---|---|
| 1 | \|1011011 [symbol] : | \|01 [symbol] : | \|10 [symbol] : | \|0111 [symbol] : | \|010 [symbol] : | \|010 [symbol] : | \|1 [symbol] : |
| | Cell₉₁ | Time₁ | Temporal | Skysat_C5 | Skysat_C5 | Flow | Remote |
| | | | mapping | Station_1 | | velocity | sensing |
| | | | | Station_2 | | | |
| 2 | \|0001111 [symbol] | \|10 [symbol] | \|10 [symbol] : | \|0011 [symbol] : | \|100 [symbol] : | \|110 [symbol] : | \|0 [symbol] : |
| | Cell₁₅ | Time₂ | Temporal | Station_1 | Station_2 | Inundation | In situ |
| | | | mapping | Station_2 | | extent, | |
| | | | | | | flow | |
| | | | | | | velocity | |
| 3 | [1011011 [symbol] | \|10 [symbol] | \|01 [symbol] : | \|1000 [symbol] : | \|001 [symbol] : | \|100 [symbol] : | \|0 [symbol] : |
| | Cell₉₁ | Time₂ | Spatial | ZY_3 | ZY_3 | Inundation | In situ |
| | | | mapping | | | extent | |
| 4 | \|0010100 [symbol] | \|01 [symbol] | \|11 [symbol] : | \|0100 [symbol] : | \|010 [symbol] : | \|010 [symbol] : | \|1 [symbol] : |
| | Cell₂₀ | Time₁ | Spatiotemporal | Skysat_C5 | Skysat_C5 | Flow | Remote |
| | | | mapping | | | velocity | sensing |

. . .

| | | | | | | | |
|---|---|---|---|---|---|---|---|
| 1024 | \|1111101 [symbol] | \|10 [symbol] | \|01 [symbol] : | \|0000 [symbol] : | \|000 [symbol] : | \|000 [symbol] : | \|0 [symbol] : |
| | Cell₁₂₅ | Time₂ | Spatial mapping | None | None | None | None |

TABLE 3
Space complexity comparison between the classical
representation method and the quantum representation
method proposed in the present disclosure

| Representation | Spatiotemporal | | Observation |
|---|---|---|---|
| method | location | Sensor | capability |
| Classical | O (MN) | O(k) | O (kp) |
| representation | | | |
| Quantum | O (log₂MN) | O(k) | O (p) |
| representation | | | |

In step S4-1, a quantum operator for a specific computation requirement is constructed.

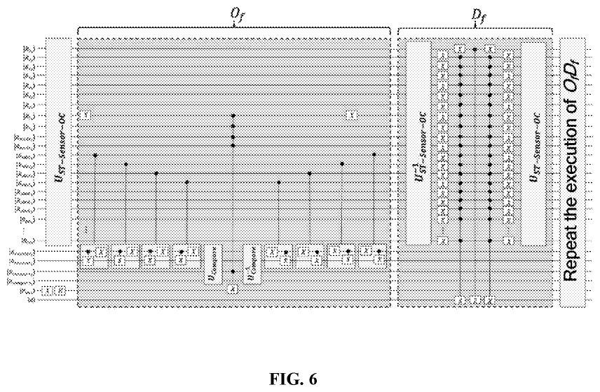

Taking the Grover's quantum search algorithm as an example, a computation requirement is constructed: “A spatial location that can be co-observed by at least two sensors within a specific time interval (14:00:00-14:10:00), and sensor observation capabilities at the corresponding location”. For this purpose, an Oracle quantum operator (O_{f}) can be constructed, which aims to mark a complete quantum state satisfying the query requirement. As shown in FIG. 6, the construction of this operator necessitates the introduction of three additional types of ancilla quantum registers:
(1) A quantum count register (R_{counter}) is used to store a binary value of the number of sensors in Rₛₗᵢₛₜ.
(2) An integer comparison register (R_{compare}) is used to compare a given binary input with a specific integer L and store a result in a qubit R_{compare}_{₁}.
(3) An ancilla register (R_{anc}) uses a single qubit serving as the marker qubit for the Grover's algorithm.

Further, based on the unified spatiotemporal observation capability quantum state constructed in the step S3-2, the execution of O_{f} includes the following four phases.
(1) Counting: The state of Rₛₗᵢₛₜ is used as input, the total number of qubits in Rₛₗᵢₛₜ that are in state |1 [symbol] is calculated, and the total number is written into R_{counter}.
(2) Comparison: An integer comparison operator (for example, the IntegerComparator operator in the Qiskit) is constructed to compare whether the count value in R_{counter} is greater than or equal to L=2, and the comparison result (if ≥L, R_{compare}_{₁}=|1 [symbol] ) is written into R_{compare}_{₁};
(3) Marking: A multi-controlled NOT gate is constructed, with Rₜ (controlled to be Time₁|01), R_{mode} (controlled to be in the spatiotemporal mode |11 [symbol] ), and R_{compare}_{₁} (controlled to be ≥|1 [symbol] ) as the control qubits, and R_{anc} as the target qubit.
(4) Inverse operation: To ensure the correctness of the Oracle quantum operator, the inverse operations of the above steps (counting, comparison, marking) are performed to disentangle registers such as R_{counter} and R_{compare}, ensuring the registers to be restored to |0 [symbol] in each iteration.

In step S4-2, computation and measurement are performed to obtain the result.

The execution of the Grover's algorithm is achieved by alternatively applying the Oracle operator O_{f} constructed in step S4-1 and a Diffuser (amplitude amplification) operator D_{f}. D_{f} aims to implement an inversion (2|ψ_{ST-Sensor-oc} [symbol] ψ_{ST-Sensor-OC}|−1) about the average amplitude, thereby amplifying the amplitude of a target quantum state marked by O_{f}, which can be measured with high probability. As shown in FIG. 6, this operator can be implemented using U_{ST-Sensor-oc} and its inverse

$${U}_{ST - Sensor - OC}^{- 1} ,$$

and an additional ancilla qubit |d [symbol] is introduced to realize a controlled-Z gate. Further, in this example, since a query condition of O_{f} is equivalent to searching a search space composed of Rₛ (126 spatial locations), Rₜ (three time intervals), and R_{mode} (three mapping modes), and there are four target quantum states (4 target spatial locations), an optimal number of iterations can be calculated as

$$⌊ \frac{π}{4} \sqrt{\frac{126 \times 3 \times 3}{4}} ⌋ = 13$$

using an optimal iteration count formula

$$( ⌊ \frac{π}{4} \sqrt{\frac{n}{m}} ⌋ ,$$

where n is the search space size and m is the number of target quantum states). Thus, the computation complexity of completing the query is derived as O(\sqrt{MN}), while the computation complexity of the classical method for completing the query is O(M). M is the number of spatial grid cells and N is the number of time intervals. This demonstrates that the quantum computing method proposed in the present application outperforms the classical method in the described application scenario (M>>N).

In the quantum circuit shown in FIG. 6, the operators O_{f}D_{f} are repeated seven times, followed by 1024 repeated measurements of all relevant registers (such as R_{ST}, Rₛₑₙₛₒᵣ, and R_{oc}) to obtain the measurement result. The circuit construction and measurements can be simulated and computed using libraries such as IBM's Qiskit. As shown in Table 4, by statistically analyzing and decoding Rₛₜ (bits 1-7) and R_{mode} (bits 8-9) of the measurement result, it is determined that under Time₁ (|01 [symbol] ) and the “spatiotemporal mapping mode” (|11 [symbol] ), four locations (decoded as Cell₁₅, Cell₁₆, Cell₂₃, Cell₂₄) have similar measurement frequencies far exceeding all other locations, totaling 1023 measurements. This verifies that the Grover's algorithm successfully amplified the measurement probability of the target states to 99.9%. Further, by analyzing Rₛₗᵢₛₜ, Rₛₗᵢₙₖ, Rₚₐ, and Rₛₘ in the complete quantum states containing Cell₁₅ (Rₛ=|0001111 [symbol] ), and performing quantum state decoding, only the two quantum states shown in Table 5 are obtained. This indicates that a set of space-air-ground sensors capable of observing Cell₁₅ during Time₁ includes ZY_3 and Station_1. ZY_3 uses “remote sensing” and can observe the “inundation extent” parameter, while Station_1 uses “in situ” sensing and can observe “water level” and “inundation extent”. The aforementioned computation result fully validates that the quantum computing method proposed in the present disclosure provides a reliable technical pathway for more efficient discovery and planning of space-air-ground sensors in the urban waterlogging monitoring scenario.

TABLE 4
Statistics and decoded information of measurement results from
the circuit for query and computation based on Rₛₜ and R_{mode}

| | | Measurement |
|---|---|---|
| Code | Decoded information | frequency |
| \|00110000111 [symbol] | Cell₂₄, Time₁, spatiotemporal | 256 |
| | mapping mode | |
| \|00101110111 [symbol] | Cell₂₃, Time₁, spatiotemporal | 235 |
| | mapping mode | |
| \|00100000111 [symbol] | Cell₁₆, Time₁, spatiotemporal | 268 |
| | mapping mode | |
| \|00011110111 [symbol] | Cell₁₅, Time₁, spatiotemporal | 263 |
| | mapping mode | |
| \|00001111111 [symbol] | Cell₇, Time₃, spatiotemporal | 1 |
| | mapping mode | |

TABLE 5
Statistics and decoded information of quantum states
including Cell₁₅ in measurement results from the
quantum circuit for query and computation

| | | | | | Measurement |
|---|---|---|---|---|---|
| No. | Rₛₗᵢₛₜ | Rₛₗᵢₙₖ | Rₚₐ | Rₛₘ | frequency |
| 1 | \|1001 [symbol] : | \|001 [symbol] : | \|010 [symbol] : | \|1 [symbol] : | 128 |
| | ZY_3, | ZY_3 | Flow velocity | Remote | |
| | Station_1 | | | sensing | |
| 2 | \|1001 [symbol] : | \|100 [symbol] : | \|110 [symbol] : | \|0 [symbol] : | 135 |
| | ZY_3, | Station_2 | Inundation | In situ | |
| | Station_1 | | extent, flow | | |
| | | | velocity | | |

A heterogeneous computing system including a processor and a quantum processor includes the processor, the quantum processor, a memory, a user interface, and a network interface. The memory is configured to store instructions, the user interface and the network interface are used for communication with another device, and the processor and quantum processor are configured to execute the instructions stored in the memory.

The present application further discloses a computer-readable storage medium storing a plurality of instructions. The instructions are adapted to be loaded by a processor to execute the method for planning physical observation tasks in a space-air-ground integrated sensor network.

Described above are merely exemplary embodiments of the present disclosure, which cannot be construed as a limitation on the scope of the present disclosure. Any equivalent changes and modifications made in accordance with the teachings of the present disclosure still fall within the scope of the present disclosure.

The present application is intended to cover any variations, purposes, or adaptive changes of the present disclosure. Such variations, purposes, or applicable changes follow the general principle of the present disclosure and include common knowledge or conventional technical means in the technical field which is not disclosed in the present disclosure. The specification and embodiments are merely considered as illustrative, and the scope and spirit of the present disclosure are defined by the claims.

What is claimed is:

1. A method for planning physical observation tasks in a space-air-ground integrated sensor network, wherein the method is executed in a heterogeneous computing system comprising a processor and a quantum processor, and comprises following steps:
step S1: obtaining, by the processor, space-air-ground sensor data and spatiotemporal observation capability data of space-air-ground sensors in a specific monitoring scenario;
step S2: discretizing, by the processor, the specific monitoring scenario to obtain discrete spatiotemporal locations; and establishing three types of mapping relationships among the discrete spatiotemporal locations, the space-air-ground sensor data, and the spatiotemporal observation capability data;
step S3: performing, by the quantum processor, based on the three types of mapping relationships, quantum encoding on the discrete spatiotemporal locations, the space-air-ground sensor data, and the spatiotemporal observation capability data, to construct a unified quantum state representation of spatiotemporal observation capabilities of the space-air-ground sensors; and
step S4: constructing, by the quantum processor, a corresponding quantum operator and quantum circuit based on an obtained computation requirement on the spatiotemporal observation capabilities, applying a quantum algorithm to compute the quantum state representation of the spatiotemporal observation capabilities of the space-air-ground sensors to generate a computation result of the spatiotemporal observation capabilities; and dynamically adjusting an observation plan or an observation parameter of at least one sensor in the space-air-ground integrated sensor network based on the computation result, to perform collaborative physical observation of a target area.

2. The method according to claim 1, wherein the step S1 comprises:
step S11: determining a spatial extent and a temporal span of the specific monitoring scenario, wherein the spatial extent is delimited by one or more polygons; and the temporal span is delimited by a start time point and an end time point; and
step S12: obtaining a set of available space-air-ground sensors within the spatial extent and the temporal span, and determining spatiotemporal observation capability data for each space-air-ground sensor in the set of available space-air-ground sensors, wherein the spatiotemporal observation capability data comprises: observation start and end time points, earth observation coverage, an observation parameter, and a sensing mode.

3. The method according to claim 2, wherein the step S2 comprises:
step S21: discretizing the spatial extent and the temporal span of the specific monitoring scenario, wherein the spatial extent is partitioned into one or more regular discrete grid cells according to a specific spatial resolution, and the temporal span is partitioned into one or more discrete time intervals according to a specific temporal resolution; and
step S22: establishing, based on the observation start and end time points and the earth observation coverage of each space-air-ground sensor, a spatiotemporal mapping relationship among each discrete grid cell within each discrete time interval, one or more sensors capable of observing the discrete grid cell within the discrete time interval, and spatiotemporal observation capabilities of the one or more sensors;
establishing a temporal mapping relationship among each discrete time interval, one or more sensors capable of observing at least one of the discrete grid cells within the discrete time interval, and spatiotemporal observation capabilities of the one or more sensors; and
establishing a spatial mapping relationship among each discrete grid cell, one or more sensors capable of observing the discrete grid cell within at least one of the discrete time intervals, and spatiotemporal observation capabilities of the one or more sensors, wherein
the three types of mapping relationships comprise: the spatiotemporal mapping relationship, the temporal mapping relationship, and the spatial mapping relationship.

4. The method according to claim 3, wherein the step S3 comprises:
step S31: performing quantum encoding to construct a spatiotemporal location quantum state representing the discrete grid cells and the discrete time intervals, wherein
the spatiotemporal location quantum state is used to identify a mode control quantum state for the spatial mapping relationship, the temporal mapping relationship, and the spatiotemporal mapping relationship, represent a sensor quantum state for the set of available space-air-ground sensors, and identify an observation capability quantum state comprising at least the observation parameter and the sensing mode; and
step S32: based on the three types of mapping relationships, performing a quantum entanglement operation using the mode control quantum state as a core control, to establish controllable associations among the spatiotemporal location quantum state, the sensor quantum state, and the observation capability quantum state, so as to form the unified quantum state representation of the spatiotemporal observation capabilities of the space-air-ground sensors.

5. The method according to claim 1, wherein the step S4 comprises:
step S41: for a specific computation requirement on the spatiotemporal observation capabilities, based on the quantum state representation of the spatiotemporal observation capabilities of the space-air-ground sensors, transforming the computation requirement into one or more quantum operators applicable to the quantum state representation, and constructing a corresponding quantum circuit;
step S42: executing the quantum circuit by applying the quantum algorithm, performing a measurement operation on an executed quantum state, and decoding a measurement result to obtain the computation result of the spatiotemporal observation capabilities.

6. The method according to claim 1, wherein:
the quantum algorithm is a Grover's search algorithm, the quantum operator comprises an Oracle operator and a Diffuser operator, and the computation requirement is a spatial location capable of being co-observed by at least two sensors within a specific time interval and corresponding observation capabilities.

7. A heterogeneous computing system for implementing the method according to claim 1, comprising: the processor, the quantum processor, a memory, a user interface, and a network interface, wherein the memory is configured to store instructions, the user interface and the network interface are used for communication with another device, and the processor and quantum processor are configured to execute the instructions stored in the memory.

8. A computer-readable non-transitory storage medium, wherein the computer-readable storage medium stores instructions, and when the instructions are executed on a computer, the method according to claim 1 is executed.
